(19) United States
(12) Patent Application Publication
(10) Pub. No.: US 2006/0144965 A1
(43) Pub. Date: Jul. 6, 2006

(54) Irrigation flushing system

(76) Inventor: Ron Keren, Hanegev (IL)

Correspondence Address: NATH & ASSOCIATES, 112 South West Street, Alexandria, VA, 22314, US

(21) Appl. No.: 11/028,662

(22) Filed: Jan. 5, 2005

(51) Int. Cl. B05B 15/00

(52) U.S. Cl. 239/542

(57) ABSTRACT

A method and a system for filling or passing a fluid through irrigation pipes equipped with dripping emitters having a non-return valve. The irrigation pipes are connected at one end to a container with the fluid and at the other end to an operable vacuum source such as vacuum pump. The vacuum source is operated to create vacuum in the pipes to suck the fluid from the container to fill the pipes. The fluid may be passed through the pipes to the vacuum source and then returned to the container by another pipe, or may be retained in the pipes without flow, or may be subjected to pressure pulses. In all cases, the non-return valves are plugged under the vacuum so as to prevent entry of external air or water into the pipes through the dripping emitters. A non pressure-compensated dripping emitter with built-in non-return valve is provided as well.

### FIELD OF THE INVENTION

This invention relates to systems for flushing (cleaning) irrigation pipes, in particular to pipes equipped with low-pressure dripping emitters.

### BACKGROUND OF THE INVENTION

Cleaning of irrigation pipes is conventionally made by flushing them with clean water or special solutions. A cleaning solution is pumped into one end of the irrigation pipe under pressure and removed from the other end. In this process, in an irrigation system equipped with dripping emitters, part of the cleaning solution is released through the emitters which may not always be desirable. To overcome the problem of solution being released from the dripping emitters, one normally uses dripping emitters that stay closed under some threshold pressure, the pipes being flushed under pressure below that threshold, so that the drippers are closed. The pressure that is necessary for flushing is usually about 2 m H₂O or higher; therefore the drippers should open only above that pressure. However, it is impossible to flush the pipes under pressure that is 2 m H₂O or higher with closed drippers, and then use the same drippers for irrigation under pressure that is lower than 2 m H₂O.

Pressure-compensated dripping emitters typically operate at pressures above 3 m H₂O. Some of these emitters (retention emitters) open under low positive pressure, and keep the dripper closed if the irrigation pipe pressure is shut-off. Such emitters are disclosed for example in U.S. Pat. No. 5,615,838 (in-line tubular emitter) and U.S. Pat. No. 5,413,282 (external emitter). Other designs remain open under low or zero pressure.

Low-pressure emitters are hard to flush as their operative pressure is low and may leak and damage the plants if higher pressure is used for flushing. In this application, operative “low pressure” is understood as hydraulic pressure less than 3 m H₂O, typically 0.2-3 m H₂O.

### SUMMARY OF THE INVENTION

In accordance with one aspect of the present invention, there is provided a method of filling or passing a fluid through an irrigation pipe equipped with one or more dripping emitters, the method comprising:

providing each of the dripping emitters with a non-return valve;

connecting one end of the irrigation pipe to a container with the fluid;

connecting second end of the irrigation pipe to an operable vacuum source;

operating the vacuum source to create reduced pressure (vacuum) in the pipe to suck the fluid from the container to fill the pipe, the non-return valve/s being plugged under the reduced pressure so as to prevent entry of external air or water into the pipe through the dripping emitters.

The fluid may be a liquid such as water, cleaning solution, disinfectant, herbicide solution, fertilizer, or even foam or gas.

The vacuum source may be a vacuum pump or a vacuum tank equipped with a vacuum pump. The level of liquid in the container is preferably maintained lower than any of the dripping emitters, to avoid any spill if the vacuum pump fails.

The method may further include either passing the fluid through the pipe to the vacuum source or retaining the fluid in the pipe without flow, in both cases the non-return valves staying plugged under the reduced pressure. Alternatively, the vacuum source may be operated intermittently so as to create pulses of reduced pressure (vacuum), for example for cleaning or mixing purposes.

The method may further include returning of the fluid from the vacuum source to the container by a return route different from the pipe. Along that return route, the fluid may be processed, e.g. filtered, or heated.

Preferably, a plurality of irrigation pipes with drip emitters are connected in parallel to the container and to the vacuum source.

According to another aspect of the present invention, there is provided a system for filling or passing a fluid through drip irrigation pipes, comprising at least one irrigation pipe equipped with one or more dripping emitters, a container with said fluid, and a vacuum source. The irrigation pipe is connected by a first end thereof to the container and by a second end thereof to the vacuum source. Each of the dripping emitters has a non-return valve. The vacuum source may be a vacuum pump, optionally with a vacuum tank; the container is preferably non-pressurized.

The system preferably comprises means for returning the fluid from the vacuum source to the container, and may also comprise means for processing the fluid at the return path. Preferably, the container is mounted low, so that the level of liquid in the container can be maintained lower than any of the dripping emitters.

According to further aspect of the present invention, there is provided a non pressure-compensated dripping emitter, comprising a built-in non-return valve, adapted for mounting to or in an irrigation pipe and for practicing the above method.

The term “not pressure-compensated” means that the emitter has no special means for limiting flow rate growth with increasing fluid pressure at its inlet, or that the emitter effectively allows higher flow rate at higher fluid pressure.

The dripping emitter has an inlet connectible to the irrigation pipe, an outlet open to the environment, and a flow path defined between them. The non-return valve includes a valve seat disposed at the flow path, in fluid communication with the inlet, and a movable plug disposed opposite the valve seat. The plug is adapted to plug the valve seat when a predetermined vacuum pressure differential is created between the inlet and the outlet, and to unplug the valve seat at least upon a predetermined minimal positive pressure differential, preferably 0.5 m H₂O.

The movable plug has a surface facing the valve seat and an opposite surface, while the flow path includes a portion downstream of the valve seat, in fluid communication with the opposite surface of the plug so that the vacuum pressure differential can urge the movable plug to plug the valve seat. The movable plug is preferably a flexible membrane. The downstream portion of the flow path may include a labyrinth.

The dripping emitter may be external, or in-line, or indeed of any type.

According to yet another aspect of the invention, there is provided an irrigation pipe equipped with the above non pressure-compensated dripping emitters and adapted for practicing the above method.

The method and the system for vacuum filling/flushing according to the present invention allow sparing use of the fluid (water, solution, disinfectant, etc.) and avoid undesirable spilling.

It will be appreciated that the method of the present invention can be used for filling or flushing any irrigation system, irrespective of its operative irrigation pressure, where the drippers have non-return valves. For example, some pressure-compensated drippers are designed to close at zero or negative pressure (vacuum). However, the above method and system for filling/flushing has special advantages for low-pressure drip irrigation pipes.

With the above method, one can use drippers which are not pressure-compensated but can irrigate under very low pressure, in order to have very low flow rate from the drippers. Such very low flow rates have certain agronomic advantages. Low flow rates make the drippers more sensitive to plugging, but since the drippers are not pressure-compensated, it is possible to raise the flow rate for a short period from time to time (daily, for example) by increasing the system inlet pressure, and thus flush the dirt out from the drippers.

Furthermore, using the above method, the liquid in the irrigation pipes may be retained without flow and without spilling outside for a prolonged time for such procedures as disinfection. Only the vacuum level in the vacuum tank has to be maintained constant against accidental penetration of air into the pipes. Foams and gases may be handled as well.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 is a schematic view of a system for vacuum flushing of drip irrigation pipes in accordance with an embodiment of the present invention;

FIG. 2 is a sectional elevation of a low-pressure dripper with a non-return valve, in accordance with an embodiment of the present invention, in operative (irrigation) state;

FIG. 3 is a sectional elevation of the dripper of FIG. 2 in vacuum flushing state; and

FIG. 4 is a perspective view of the base part in the dripper of FIG. 2.

### DETAILED DESCRIPTION OF THE EMBODIMENT

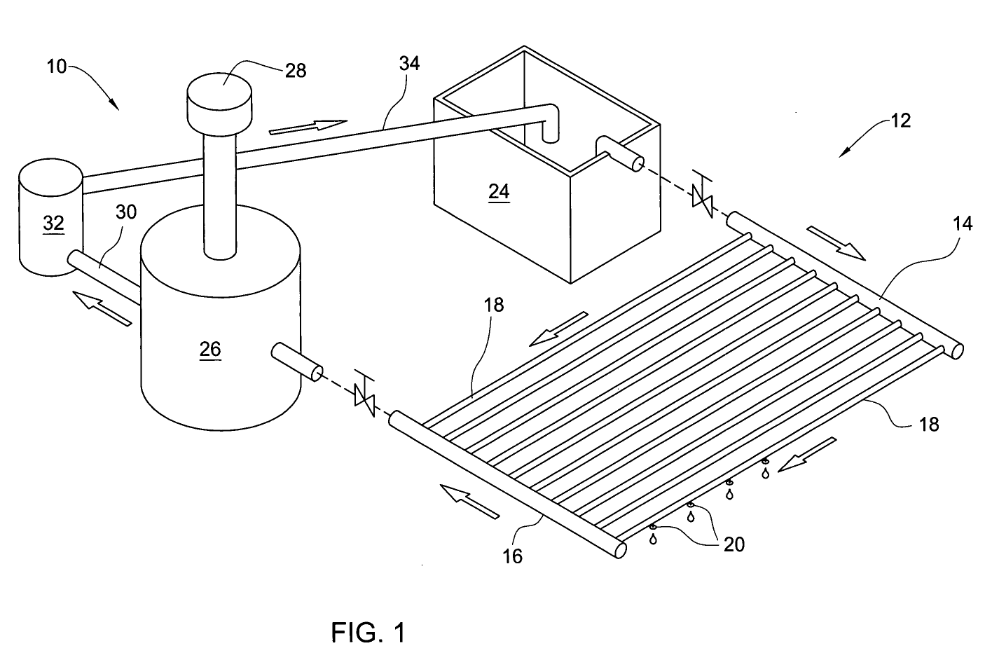

With reference to FIG. 1, there is shown schematically an arrangement 10 for vacuum-flushing a drip-irrigation system 12. The drip-irrigation system 12 comprises main water supply pipes 14 and 16, and a plurality of branch pipes 18 connected to the main pipes. The branch pipes 18 are equipped with drip emitters 20 having non-return valves (shown in detail below).

In normal irrigation operation, one or both main pipes 14 and 16 are connected to a pressurized source of irrigation water (not shown). The irrigation water flows under low operative pressure P_{O} into the branch pipes 18 and leaves them through the drip emitters 20. The drip emitters 20 are open under zero or very low positive pressure so that the system 12 may perform irrigation under 20-30 cm H₂O.

The flushing arrangement 10 includes a non-pressurized tank 24 for flushing solution, a vacuum tank 26 equipped with a vacuum pump 28, drain pipe 30, pressure pump 32 and a return pipe 34.

The solution tank 24 is operatively connectible to the main pipe 14 while the vacuum tank 26 is operatively connectible to the main pipe 16. The level of the flushing solution in the solution tank 24 is preferably lower than any of the drippers 20 in order to prevent any positive pressure on the drippers, while the flushing solution is in fluid communication with the drippers. The drain pipe 30 connects the vacuum tank 26 to the inlet of the pressure pump 32 while the return pipe 34 connects the pressure pump outlet to the flushing tank 24.

For performing a flushing operation, the main pipes 14 and 16 are disconnected from the irrigation water source and connected to the solution tank 24 and the vacuum tank, respectively. The vacuum pump 28 reduces the pressure in the vacuum tank 26 and in the connected irrigation system 12 to vacuum pressure P_{V} which is below the atmospheric pressure P_{A}. Thereby the flushing solution from the tank 24 (which is under atmospheric pressure) is sucked into the main pipe 14, into the branch pipes 18, and into the main pipe 16. From the main pipe 16, the solution flows into the vacuum tank 26. Via the drain pipe 30, the solution enters the pressure pump 32 which pumps it back to the tank 24 through the return pipe 34.

As the drippers are under negative pressure differential ΔP=P_{V}−P_{A} with respect to the atmosphere, their non-return valves keep them closed and no external matter is sucked into the irrigation system.

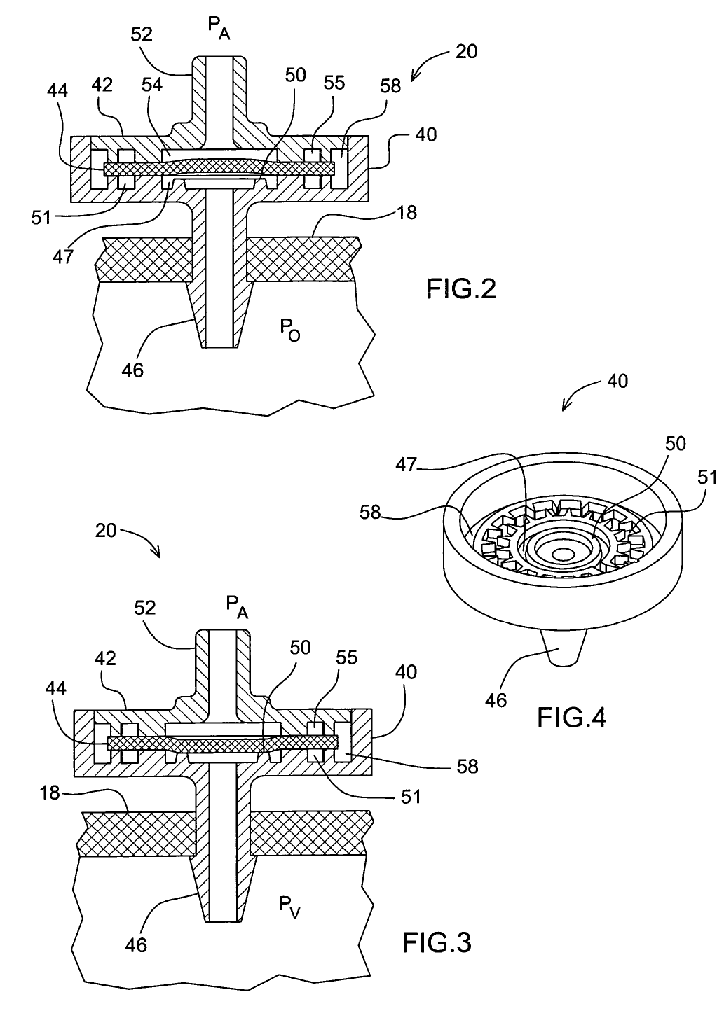

The low-pressure dripping emitter 20 is shown in detail in the sectional view of FIGS. 2 and 3, and the perspective view of FIG. 4. The emitter comprises a base 40, a cover 42, and a membrane 44 snapped between the base and the cover. The base 40 has an inlet tube 46 with a barb, tightly insertable in the wall of the branch pipe 18, and an inlet chamber 47 connected to the downstream end of the inlet tube 46. The inlet chamber is defined partially by inlet surface of the membrane 44 and has an annular valve seat 50 surrounding the inlet tube opening and located opposite the inlet surface of the membrane 44. The inlet chamber is connected to a labyrinth 51.

The cover 42 has an outlet tube 52 connected upstream to an outlet chamber 54 which in its turn is connected to the exit of another labyrinth 55. The inlet chamber 47 and the outlet chamber 54 are divided by the membrane 44 which also divides the labyrinths 51 and 55. The labyrinths 51 and 55 are however connected by an annular chamber 58 formed between the base 40 and the cover 42.

The membrane 44 and the valve seat 50 constitute a non-return valve. As shown in FIG. 2, under positive pressure differential P_{O}−P_{A}, the membrane 44 bends away from the valve seat 50. Thereby, the flow path between the inlet 46 and the outlet 52, via the valve seat 50, the labyrinth 51, the annular chamber 58, and the labyrinth 55 passes water from the pipe 18 to the environment. This is the normal irrigation operation, as described above. Preferably, the non-return valve is normally open (under zero pressure differential), however it is necessary only to make sure that all the drippers open at about 0.2 m H₂O.

During flushing operation, the reduced (vacuum) pressure P_{V} in the pipe 18 creates negative pressure differential P_{V}−P_{A} across the membrane 44, bending and urging the membrane to the valve seat 50, whereby the non-return valve is plugged. The pressure differential is normally higher than 2 m H₂O, but in small systems it can be lower.

Although a description of a specific dripper has been presented, it is contemplated that various changes could be made without deviating from the scope of the present invention. For example, the dripping emitter with non-return valve may be an in-line dripper (built into the pipe), with or without a labyrinth. The present flushing system and method could be modified and used for any purpose requiring filling the irrigation system with some liquid, such as disinfectant or herbicide solution, or even gas or foam. The liquid may be passed directly through the vacuum pump, the return branch of the system may include some means for processing the liquid, etc.

1. A method of filling or passing a fluid through an irrigation pipe equipped with one or more dripping emitters, the method comprising:
providing each of said dripping emitters with a non-return valve;
connecting the first end of said irrigation pipe to a container with said fluid;
connecting the second end of said irrigation pipe to an operable vacuum source;
operating said vacuum source to create reduced pressure (vacuum) in the pipe so that said fluid flows from said container filling said pipe while the non-return valves are plugged and prevent entry of external air or water into said pipe through said dripping emitters.

2. The method of claim 1, wherein said fluid is one of the following: water, cleaning solution, disinfectant, herbicide solution, fertilizing solution.

3. The method of claim 1, wherein said vacuum source is a vacuum pump or a vacuum tank.

4. The method of claim 1, further including one or both of the following: passing said fluid through said pipe to said vacuum source, and retaining said fluid in said pipe without flow, in either case said non-return valves staying plugged under said reduced pressure.

5. The method of claim 1, further including returning of said fluid from said vacuum source to said container by a return route different from said pipe.

6. The method of claim 5, further including processing of said fluid on said return route.

7. The method of claim 1, wherein a plurality of irrigation pipes with drip emitters are connected in parallel to said container and to said vacuum source.

8. The method of claim 1, wherein said vacuum source is operated intermittently so as to create pulses of reduced pressure (vacuum).

9. The method of claim 1, wherein said fluid is liquid and the level thereof in said container is maintained lower than any of said dripping emitters.

10. An irrigation pipe equipped with non pressure-compensated dripping emitters and non-return valves, adapted for practicing the method of claim 1.

11. The irrigation pipe of claim 10, wherein said non-return valves are built in said non pressure-compensated dripping emitters.

12. A non pressure-compensated dripping emitter comprising a built-in non-return valve, adapted for mounting to an irrigation pipe and suitable for practicing the method of claim 1.

13. The dripping emitter of claim 12 having an inlet connectible to said irrigation pipe, an outlet open to the environment, and a flow path defined therebetween, wherein said non-return valve includes a valve seat disposed at said flowpath in fluid communication with said inlet, and a movable plug disposed opposite said seat and adapted to plug said valve seat when a predetermined vacuum pressure differential is created between said inlet and said outlet, and to unplug said seat at least upon a predetermined minimal positive pressure differential.

14. The dripping emitter of claim 13, wherein said movable plug has a surface facing said valve seat and an opposite surface, and said flowpath includes a portion downstream of said valve seat, in fluid communication with said opposite surface so that said vacuum pressure differential can urge said movable plug to plug said valve seat.

15. The dripping emitter of claim 14, wherein the flowpath portion downstream of said valve seat includes a labyrinth.

16. The dripping emitter of claim 14, wherein said movable plug is a flexible membrane.

17. A system for filling or passing a fluid through drip irrigation pipes, comprising at least one irrigation pipe equipped with one or more dripping emitters, a container with said fluid, and a vacuum source, said at least one irrigation pipe being connected by a first end thereof to said container and by a second end thereof to said vacuum source,
wherein each of said dripping emitters has a non-return valve.

18. The system of claim 17, wherein said vacuum source is a vacuum pump, optionally with a vacuum tank.

19. The system of claim 17, further comprising means for returning said fluid from said vacuum source to said container.

20. The system of claim 19, further comprising means for processing said fluid while returning it from said vacuum source to said container.

21. The system of claim 17, wherein said container is non-pressurized.

22. The system of claim 17, wherein said fluid is liquid and said container is located at height that allows maintaining of the level of said liquid lower than any of said dripping emitters.
